(19) United States
(12) Patent Application Publication
(10) Pub. No.: US 2014/0112354 A1
(43) Pub. Date: Apr. 24, 2014

(54) METHOD, APPARATUS, AND SYSTEM FOR PROCESSING STREAMING MEDIA DATA

(71) Applicant: HUAWEI TECHNOLOGIES CO., LTD., Shenzhen (CN)

(72) Inventor: Yuejing Yin, Beijing (CN)

(73) Assignee: HUAWEI TECHNOLOGIES CO., LTD., Shenzhen (CN)

(21) Appl. No.: 14/143,477

(22) Filed: Dec. 30, 2013

Related U.S. Application Data
(63) Continuation of application No. PCT/CN2011/085138, filed on Dec. 31, 2011.

(51) Int. Cl. H04L 29/06

(52) U.S. Cl. CPC H04L 65/605
USPC 370/476

(57) ABSTRACT

Embodiments of the present invention relate to a method, an apparatus, and a system for processing streaming media data. An embodiment of the present invention provides a method for processing streaming media data, including: receiving, by a streaming media data encapsulation device, an application layer streaming media data block sent by a streaming media server, determining a source format and a target format of the application layer streaming media data block, where the number of data packets in the application layer streaming media data block is greater than the maximum integral number of data packets that are in the source format and can be contained in one packet in the target format, and segmenting and encapsulating, by the streaming media data encapsulation device, the data packets in the application layer streaming media data block into at least two packets in the target format according to the source format and the target format.

### CROSS-REFERENCE TO RELATED APPLICATIONS

This application is a continuation of International Application No. PCT/CN2011/085138, filed on Dec. 31, 2011, which is hereby incorporated by reference in its entirety.

### TECHNICAL FIELD

Embodiments of present invention relate to the field of communications technologies, and in particular, to a method, an apparatus, and a system for processing streaming media data.

### BACKGROUND

In an existing transport stream (TS)/UDP streaming media service, when sending streaming media data to a network adapter, a streaming media server needs to encapsulate the streaming media data into a UDP packet, and then sends the encapsulated UDP packet to the network adapter. In the TS/UDP streaming media service, source content is a TS stream or a TS file, and the length of each TS packet is 188 bytes. For the purpose of simplifying processing, the length of streaming media payload in the UDP packet during each encapsulation by the streaming media server is an integral multiple of 188 bytes. A UDP head occupies 8 bytes, and the size of an MTU (Maximum Transmission Unit, maximum transmission unit) in the Ethernet is 1500 bytes. Therefore, the UDP packet sent to the network adapter by the streaming media server each time contains a maximum of 7 TS packets.

By analyzing the prior art, the inventor thinks that the prior art has at least the following problems:

In the prior art, a streaming media server sends a maximum of 7 TS packets to a network adapter at a time. The data amount of a streaming media service is large, so the streaming media server needs to frequently communicate with the network adapter, which increases the processing load of the streaming media server. In addition, the streaming media server encapsulates 7 TS packets into a UDP packet at a time, and sends the encapsulated UDP packet to the network adapter. The data amount of the streaming media service is large, so the streaming media server needs to frequently segment and encapsulate streaming media data, which further increases the processing load of the streaming media server.

### SUMMARY

An objective of embodiments of the present invention is to provide a method, an apparatus, and a system for processing streaming media data, which can reduce the processing load of a streaming media server.

An embodiment of the present invention provides a method for processing streaming media data, including:

determining, by a streaming media server, a source format and a target format of application layer streaming media data;

determining, by the streaming media server, according to the source format and the target format, the maximum integral number of data packets that are in the source format and can be contained in one packet in the target format; and

sending, by the streaming media server, an application layer streaming media data block to a streaming media data encapsulation device, where the number of data packets in the application layer streaming media data block is greater than the maximum integral number.

An embodiment of the present invention provides another method for processing streaming media data, including:

receiving an application layer streaming media data block sent by a streaming media server;

determining a source format and a target format of the application layer streaming media data block, where the number of data packets in the application layer streaming media data block is greater than the maximum integral number of data packets that are in the source format and can be contained in one packet in the target format; and

determining a size of each data packet in the application layer streaming media data block according to the source format, and segmenting and encapsulating the data packets in the application layer streaming media data block into at least two packets in the target format according to the size of each data packet and the maximum integral number, where each segmented and encapsulated packet in the target format contains the integral number of data packets in the source format.

An embodiment of the present invention provides a streaming media server, including:

a determiner, configured to determine a source format and a target format of application layer streaming media data, where

the determiner is further configured to determine, according to the source format and the target format, the maximum integral number of data packets that are in the source format and can be contained in one packet in the target format; and

a sender, configured to send an application layer streaming media data block to a streaming media data encapsulation device, where the number of data packets in the application layer streaming media data block is greater than the maximum integral number determined by the determiner.

An embodiment of the present invention provides a streaming media data encapsulation device, including:

a receiver, configured to receive an application layer streaming media data block sent by a streaming media server;

a determiner, configured to determine a source format and a target format of the application layer streaming media data block received by the receiver, where the number of data packets in the application layer streaming media data block received by the receiver is greater than the maximum integral number of data packets that are in the source format and can be contained in one packet in the target format, where,

the determiner is further configured to determine a size of each data packet according to the source format; and

a segmentation encapsulator, configured to segment and encapsulate the data packets in the application layer streaming media data block received by the receiver into at least two packets in the target format according to the size of each data packet that is determined by the determiner and the maximum integral number, where each segmented and encapsulated packet in the target format contains the integral number of data packets in the source format.

An embodiment of the present invention provides a system for processing streaming media data, including: a streaming media server and a streaming media data encapsulation device, where,

the streaming media server is configured to determine a source format and a target format of application layer streaming media data, and send an application layer streaming media data block to the streaming media data encapsulation device after determining, according to the source format and the target format, the maximum integral number of data packets that are in the source format and can be contained in one packet in the target format, where the number of data packets in the application layer streaming media data block is greater than the maximum integral number; and

the streaming media data encapsulation device is configured to receive the application layer streaming media data block sent by the streaming media server, determine a source format and a target format of the application layer streaming media data block, determine a size of each data packet in the application layer streaming media data block according to the source format, and segment and encapsulate the data packets in the application layer streaming media data block into at least two packets in the target format according to the size of each data packet and the maximum integral number, where each segmented and encapsulated packet in the target format contains the integral number of data packets in the source format.

In the method, the apparatus, and the system for processing streaming media data that are provided by the embodiments of the present invention, the number of data packets in an application layer streaming media data block is greater than the maximum integral number of data packets that are in a source format and can be contained in one packet in a target format, thereby decreasing the number of times of communication between a streaming media server and a streaming media data encapsulation device, and reducing the processing load of the streaming media server; in addition, the streaming media server sends the application layer streaming media data block to the streaming media data encapsulation device, and the streaming media data encapsulation device segments and encapsulates the application layer streaming media data block, thereby further reducing the processing load of the streaming media server.

### BRIEF DESCRIPTION OF DRAWINGS

FIG. 1 is an architecture diagram of processing streaming media data according to an embodiment of the present invention;

FIG. 2 is a flowchart of a method for processing streaming media data according to an embodiment of the present invention;

FIG. 3 is a flowchart of another method for processing streaming media data according to an embodiment of the present invention;

FIG. 4 is a flowchart of an implementation of a method for processing streaming media data according to an embodiment of the present invention;

FIG. 5 is a schematic structural diagram of a system for processing streaming media data according to an embodiment of the present invention;

FIG. 6 is a schematic structural diagram of a streaming media server according to an embodiment of the present invention; and

FIG. 7 is a schematic structural diagram of a streaming media data encapsulation device according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

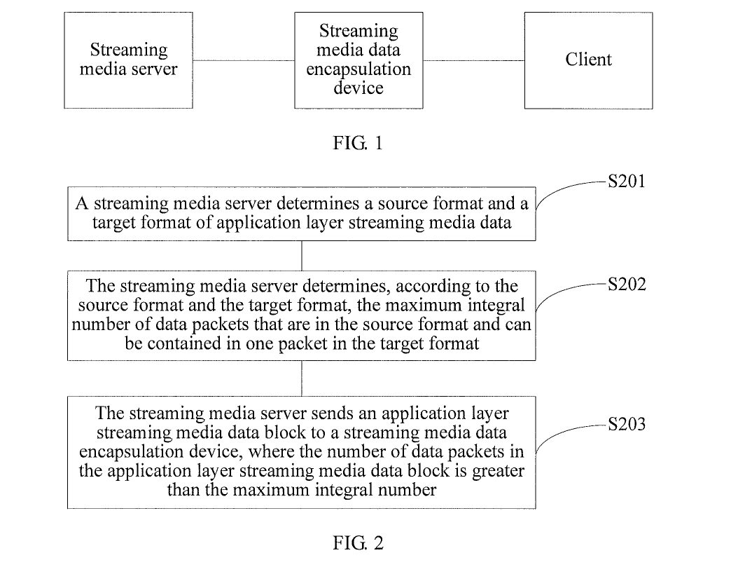

As shown in FIG. 1, FIG. 1 is an architecture diagram of processing streaming media data according to an embodiment of the present invention. A streaming media server sends an application layer streaming media data block to a streaming media data encapsulation device, and the streaming media data encapsulation device segments and encapsulates the received application layer streaming media data block into packets, and sends each segmented and encapsulated packet to a client.

As an example rather than a limitation, the streaming media data encapsulation device may be a network adapter or a device that has a packet encapsulation function.

Based on the architecture diagram shown in FIG. 1, an embodiment of the present invention provides a method for processing streaming media data. As shown in FIG. 2, the method specifically includes:

S201: A streaming media server determines a source format and a target format of application layer streaming media data.

S202: The streaming media server determines, according to the source format and the target format, the maximum integral number of data packets that are in the source format and can be contained in one packet in the target format.

It should be noted that, the streaming media server determines a size of the data packets in the source format according to the source format, and determines, according to the size of the data packets and the capacity of the packet in the target format, the maximum integral number of data packets that are in the source format and can be contained in one packet in the target format.

For example, if the source format is TS file or TS stream, the target format is TS/UDP, and a size of a TS packet is 188 bytes. An MTU is 1500 bytes, an IP head occupies 20 bytes, and a UDP head occupies 8 bytes, and therefore the load of a UDP packet is a maximum of 1472 bytes, and the capacity of the UDP packet is 1472 bytes, that is, a maximum of 1472 bytes. Therefore, the streaming media server may determine, according to the size of the TS packet and the capacity of the UDP packet, that a packet in a TS/UDP format may contain a maximum of 7 TS packets. For another example, if the source format is TS file or TS stream and the target format is TS/RTP/UDPTS/RTP/UDP, based on the same reason, the streaming media server may determine that a TS/RTP/UDPUDP packet may contain a maximum of 7 TS packets. For other target formats, for example, TS/TCP, a similar manner may be adopted to determine the maximum integral number of data packets that are in the source format and can be contained in the packet in the target format.

It should be noted that, the TS/UDP format represents a UDP packet in a TS format, and a TS/RTP/UDP format represents a UDP packet in an RTP format, where an RTP packet contains data packets in the TS format.

For other source formats and target formats, for example, if the source format is H.264 and the target format is H.264/RTP/UDP, a similar manner may be adopted to determine.

S203: The streaming media server sends an application layer streaming media data block to a streaming media data encapsulation device, where the number of data packets in the application layer streaming media data block is greater than the maximum integral number.

For example, if the source format is TS file or TS stream and the target format is TS/UDP, a UDP packet can contain a maximum of 7 TS packets, and the number of TS packets in the application layer streaming media data block sent to the streaming media data encapsulation device by the streaming media server is greater than 7, thereby decreasing the number of times of communication between the streaming media server and the streaming media data encapsulation device, and reducing the processing load of the streaming media server. For other target formats, for example, TS/RTP/UDPTS/RTP/UDP, a similar manner may be adopted to send the application layer streaming media data block to the streaming media data encapsulation device.

It should be noted that, for other source formats and target formats, for example, the source format is H.264 and the target format is H.264/RTP/UDP, a similar manner may be adopted to send the application layer streaming media data block to the streaming media data encapsulation device.

It should be noted that, the streaming media server may determine the number of data packets in the application layer streaming media data block according to real time of a streaming media service. Specifically, for some services that need to consider user experience, the number of data packets in the application layer streaming media data block needs to at least ensure that the user experience is not affected. As an example rather than a limitation, in a specific implementation manner, the streaming media server may determine the number of data packets in the application layer streaming media data block according to an average play speed of streaming media data and a sending time interval of sending the application layer streaming media data block. For example, an online on-demand service is sent at least according to an average play speed of the streaming media data, so as to ensure the playing continuity. If the average play speed of the streaming media data is 2 Mbit/s, that is, the streaming media server is required to send data of 2 Mbits every second, and if the application layer streaming media data block is data in the TS format, and an application layer streaming media server sends the application layer streaming media data block to the streaming media data encapsulation device every second, the streaming media server is required to send 1400 TS packets to the streaming media data encapsulation device every second.

It should be noted that, the number of data packets in the application layer streaming media data block may be an integral multiple of the maximum integral number, thereby facilitating encapsulation processing by the streaming media data encapsulation device, and reducing the processing complexity of segmentation and encapsulation by the streaming media data encapsulation device.

It should be noted that, after the streaming media server sends the application layer streaming media data block to the streaming media data encapsulation device, the streaming media data encapsulation device segments and encapsulates the application layer streaming media data block.

In the method for processing streaming media data that is provided by the embodiment of the present invention, the number of data packets in an application layer streaming media data block is greater than the maximum integral number of data packets that are in a source format and can be contained in one packet in a target format, thereby decreasing the number of times of communication between a streaming media server and a streaming media data encapsulation device, and reducing the processing load of the streaming media server; in addition, the streaming media server sends the application layer streaming media data block to the streaming media data encapsulation device, and the streaming media data encapsulation device segments and encapsulates the application layer streaming media data block, thereby further reducing the processing load of the streaming media server; in addition, the streaming media server determines the number of data packets in the application layer streaming media data block according to real time of a streaming media service, thereby ensuring playing continuity of streaming media data, and improving user experience; in addition, the number of data packets in the application layer streaming media data block is an integral multiple of the maximum integral number, thereby helping the streaming media data encapsulation device segment and encapsulate the application layer streaming media data block, and simplifying the complexity of encapsulation processing.

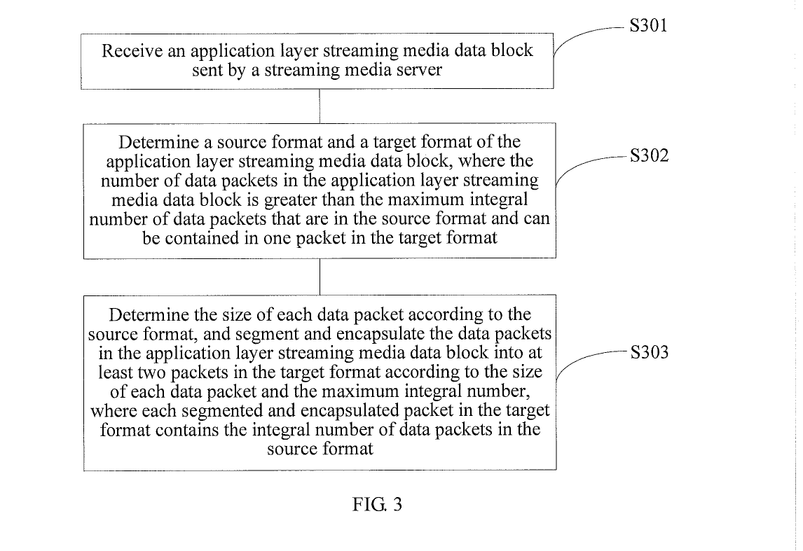

Based on the architecture diagram shown in FIG. 1, an embodiment of the present invention provides another method for processing streaming media data. As shown in FIG. 3, the method specifically includes:

S301: Receive an application layer streaming media data block sent by a streaming media server.

It should be noted that, the method embodiment is executed by a streaming media data encapsulation device, and the streaming media data encapsulation device may include a network adapter or a device that has a packet encapsulation function.

S302: Determine a source format and a target format of the application layer streaming media data block, where the number of data packets in the application layer streaming media data block is greater than the maximum integral number of data packets that are in the source format and can be contained in one packet in the target format.

As an example rather than a limitation, the following is used as an example: the source format is TS file or TS stream and the target format is TS/UDP. A TS packet is 188 bytes, and a UDP head occupies 8 bytes, and therefore a UDP packet contains a maximum of 7 TS packets, and the number of TS packets in the application layer streaming media data block is greater than 7.

It should be noted that, the number of data packets in the application layer streaming media data block is an integer.

It should be noted that, a source format and a target format of the application layer streaming media data block may be determined in any one of the following manners:

Manner 1: The application layer streaming media data block carries a source format identifier and a target format identifier, and the streaming media data encapsulation device determines the source format and the target format of the application layer streaming media data block according to the source format identifier and the target format identifier that are carried in the application layer streaming media data block.

Manner 2: The source format and the target format of the application layer streaming media data block are determined according to pre-saved configuration parameters, where the configuration parameters include a source format identifier and a target format identifier of the application layer streaming media data block.

S303: Determine a size of each data packet according to the source format, and segment and encapsulate the data packets in the application layer streaming media data block into at least two packets in the target format according to the size of each data packet and the maximum integral number, where each segmented and encapsulated packet in the target format contains the integral number of data packets in the source format.

The data packets in the application layer streaming media data block are segmented and encapsulated into at least two packets in the target format specifically in the following manner:

segmenting the data packets in the application layer streaming media data block into at least two segments, where the number of data packets contained in each segment is an integer and not greater than the maximum integral number; and separately encapsulating the at least two segments into packets in the target format.

For example, if the source format is TS stream or TS file and the target format is TS/UDP, it indicates that a TS packet in the source format needs to be encapsulated into a UDP packet in the TS format. The size of the TS packet is 188 bytes and an MTU value is 1500 bytes, and therefore a UDP packet can carry a maximum of 7 TS packets, and the application layer streaming media data block may be segmented according to a rule that each segment is not greater than 7 TS packets. For example, if the application layer streaming media data block contains 35 TS packets, in a manner where every 5 TS packets are segmented into a segment, the application layer streaming media data block is segmented and encapsulated into 7 UDP packets, where the format of each UDP packet is shown in the following table:

| | | | | | |
|---|---|---|---|---|---|
| UDP head | TS packet | TS packet | TS packet | TS packet | TS packet |

For another example, if the source format is TS stream or TS file and the target format is TS/RTP/UDPTS/RTP/UDP, it indicates that multiple TS packets in the source format need to be first added with an RTP head and encapsulated into packets in an RTP (Real-Time Transport Protocol, Real-Time Transport Protocol) format, and then the packets in the RTP format need to be added with a UDP head and encapsulated into UDP packets. The size of the TS packet is 188 bytes, the UDP head occupies 8 bytes, and the RTP head occupies 12 bytes, and therefore a UDP packet can carry a maximum of 7 TS packets, and the application layer streaming media data block may be segmented in a manner where each segment is not greater than 7 TS packets. For example, in a manner where every 5 TS packets are segmented into a segment, each segmented segment is encapsulated into a UDP packet. The difference of the UDP packet in the RTP format from the UDP packet in the TS format lies in that the UDP packet in the RTP format contains an extra RTP head, as shown in the following table:

| | | | | | | |
|---|---|---|---|---|---|---|
| UDP | RTP | TS | TS packet | TS packet | TS packet | TS packet |
| head | head | packet | | | | |

It should be noted that, for other target formats, a similar manner may be adopted to expand a corresponding function of the streaming media data encapsulation device. As an example rather than a limitation, if the source format is TS file or TS stream and the target format is TS/TCP, the maximum integral number of TS packets that can be contained in a TCP packet is determined in a similar manner, and the application layer streaming media data block is segmented and encapsulated in a similar manner, which are not repeated again herein.

For other source formats and target formats, for example, if the source format is H.264 and the target format is H.264/RTP/UDP, a similar manner may be adopted to expand a corresponding function of the streaming media data encapsulation device, which is not repeated again herein.

It should be noted that, the data packets in the application layer streaming media data block may be segmented into at least two segments in the following manner:

segmenting the data packets in the application layer streaming media data block into at least two segments according to the maximum integral number. For example, when the source format is TS file or TS stream and the target format is TS/RTP/UDP, i, the application layer streaming media data block is segmented by segmenting 7 TS packets to a segment. If the application layer streaming media data block contains 1400 TS packets, the 1400 TS packets are segmented into 200 segments, where each segment contains 7 TS packets, and the 200 segments are separately encapsulated into UDP packets in the RTP format.

In the method for processing streaming media data that is provided by the embodiment of the present invention, the number of data packets in an application layer streaming media data block is greater than the maximum integral number of data packets that are in a source format and can be contained in one packet in a target format, thereby decreasing the number of times of communication between a streaming media server and a streaming media data encapsulation device, and reducing the processing load of the streaming media server; in addition, the streaming media server sends the application layer streaming media data block to the streaming media data encapsulation device, and the streaming media data encapsulation device encapsulates the application layer streaming media data block, thereby further reducing the processing load of the streaming media server; in addition, the streaming media data encapsulation device segments and encapsulates the application layer streaming media data block according to a source format and a target format of the application layer streaming media data block, so that the streaming media data encapsulation device can adaptively encapsulate various types of application layer streaming media data blocks; in addition, the application layer streaming media data block carries a source format identifier and a target format identifier, so that the streaming media data encapsulation device can simultaneously process various types of application layer streaming media data blocks; in addition, the source format and the target format of the application layer streaming media data block can be learned by means of pre-saved configuration parameters, thereby further reducing overheads of communication between the streaming media server and the streaming media data encapsulation device, and saving network bandwidth; furthermore, the packet in the target format that is obtained by encapsulating by the streaming media data encapsulation device contains the integral number of data packets in the source format, thereby simplifying the complexity of encapsulation processing; and furthermore, the streaming media data encapsulation device segments the data packets in the application layer streaming media data block according to the maximum integral number of data packets that are in the source format and can be contained in the packet in the target format, so that the encapsulated packet in the target format contains the maximum number of data packets, thereby decreasing the number of times of communication between the streaming media data encapsulation device and a client, and reducing the processing load of the streaming media data encapsulation device.

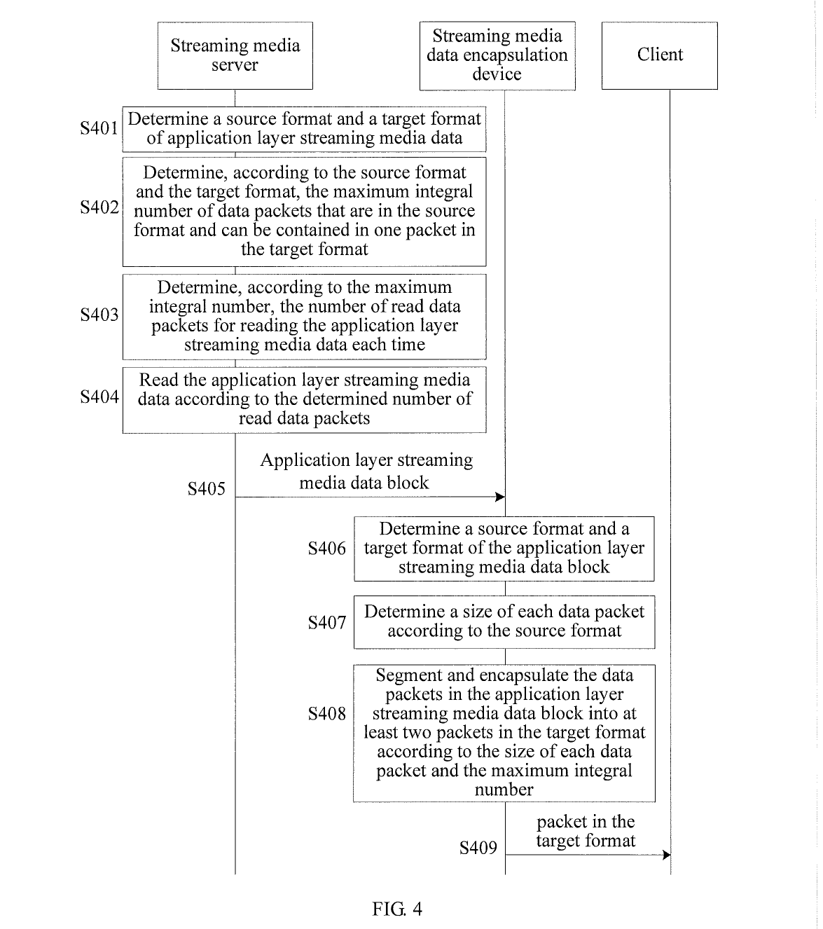

As shown in FIG. 4, FIG. 4 is a flowchart of an implementation of a method for processing streaming media data according to an embodiment of the present invention, which specifically includes:

S401: A streaming media server determines a source format and a target format of application layer streaming media data.

S402: The streaming media server determines, according to the source format and the target format, the maximum integral number of data packets that are in the source format and can be contained in one packet in the target format.

It should be noted that, the streaming media server determines a size of the data packet in the source format according to the source format, and determines, according to the size of the data packet and the capacity of the packet in the target format, the maximum integral number of data packets that are in the source format and can be contained in one packet in the target format.

For example, if the source format is TS file or TS stream, the target format is TS/UDP, the size of a TS packet is 188 bytes, and a UDP packet is a maximum of 1472 bytes, the streaming media server may determine, according to the size of the TS packet and the capacity of the UDP packet, that a packet in a TS/UDP format may contain a maximum of 7 TS packets.

For another example, if the source format is TS file or TS stream and the target format is TS/RTP/UDP, based on the same reason, the streaming media server may determine that a TS/RTP/UDP packet may contain a maximum of 7 TS packets. For other target formats, for example, TS/TCP, a similar manner may be adopted to determine the maximum integral number of data packets that are in the source format and can be contained in the packet in the target format.

For other source formats and target formats, for example, if the source format is H.264 and the target format is H.264/RTP/UDP, a similar manner may be adopted to determine.

S403: The streaming media server determines, according to the maximum integral number, the number of read data packets for reading the application layer streaming media data each time.

It should be noted that, the streaming media server may determine the number of read data packets according to the size of a cache of the streaming media server, where in a specific implementation manner, the number of read data packets is in a positive correlation with the size of the cache of the streaming media server, and the number of read data packets may increase with the increase of the cache of the streaming media server, and decrease with the decrease of the cache of the streaming media server.

It should be noted that, if the cache of the streaming media server allows, the number of read data packets may be as large as possible.

S404: The streaming media server reads the application layer streaming media data according to the determined number of read data packets.

It should be noted that, if the number of unread data packets is less than the number of read data packets, the data packets are read according to an actual number of data packets, and otherwise, the data packets are read according to the number of read data packets.

S405: The streaming media server sends an application layer streaming media data block to a streaming media data encapsulation device, where the number of data packets in the application layer streaming media data block is greater than the maximum integral number.

For example, if the source format is TS file or TS stream and the target format is TS/UDP, a UDP packet can contain a maximum of 7 TS packets, and the number of TS packets in the application layer streaming media data block sent to the streaming media data encapsulation device by the streaming media server is greater than 7, thereby decreasing the number of times of communication between the streaming media server and the streaming media data encapsulation device, and reducing the processing load of the streaming media server. For other target formats, for example, TS/RTP/UDP, a similar manner may be adopted to send the application layer streaming media data block to the streaming media data encapsulation device.

It should be noted that, for other source formats and target formats, for example, the source format is H.264 and the target format is H.264/RTP/UDP, a similar manner may be adopted to send the application layer streaming media data block to the streaming media data encapsulation device.

It should be noted that, the streaming media server may determine the number of data packets in the application layer streaming media data block according to real time of a streaming media service. Specifically, for some services that need to consider user experience, the number of data packets in the application layer streaming media data block needs to at least ensure that the user experience is not affected. As an example rather than a limitation, in a specific implementation manner, the streaming media server may determine the number of data packets in the application layer streaming media data block according to an average play speed of streaming media data and a sending time interval of sending the application layer streaming media data block. For example, an online on-demand service is sent at least according to an average play speed of the streaming media data, so as to ensure playing continuity. If the average play speed of the streaming media data is 2 Mbit/s, that is, the streaming media server is required to send data of 2 Mbits every second, and if the application layer streaming media data block is data in the TS format, and an application layer streaming media server sends the application layer streaming media data block to the streaming media data encapsulation device every second, the streaming media server is required to send 1400 TS packets to the streaming media data encapsulation device every second.

It should be noted that, the number of data packets in the application layer streaming media data block may be an integral multiple of the maximum integral number, thereby facilitating encapsulation processing by the streaming media data encapsulation device, and reducing the processing complexity of segmentation and encapsulation by the streaming media data encapsulation device. For example, if the source format of the application layer streaming media data block is TS file or TS stream, and the target format is TS/UDP, a UDP packet of the target format can carry a maximum of 7 TS packets, and the number of data packets in the application layer streaming media data block sent by the streaming media server is an integral multiple of 7, for example, the number of data packets in the application layer streaming media data block sent by the streaming media server is 1400. For other types of source formats and target formats, for example, the source format is H.264, and the target format is H.264/RTP/UDP, a similar manner may be adopted to expand a corresponding function of the streaming media data encapsulation device, which is not repeated again herein.

Optionally, when the cache of the streaming media data encapsulation device allows, in the process of sending the application layer streaming media data block to the streaming media data encapsulation device, the streaming media server may increase the number of data packets sent each time to the streaming media data encapsulation device each time as many as possible, so as to decrease the number of times of communication between the streaming media server and the streaming media data encapsulation device, thereby further reducing the processing load of the streaming media server.

It should be noted that, if the number of data packets read by the streaming media server is less than the maximum integral number, the application layer streaming media data block is sent to the streaming media data encapsulation device according to an actual number of read data packets.

Preferably, the number of read data packets may be greater than or equal to the maximum integral number.

It should be noted that, the embodiment of the present invention does not limit specific manners for the streaming media server to send the application layer streaming media data block to the streaming media data encapsulation device. As an example rather than a limitation, the streaming media server may customize a new socket structure type, where the structure contains a source format identifier, a target format identifier, and payload of the application layer streaming media data block, as shown in the following table:

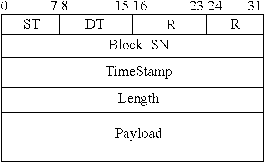

The ST is the source format identifier, used to represent the source format of the application layer streaming media data block, the identifier DT is the target format identifier, used to represent the target format of the application layer streaming media data block; the Block_SN is a block number of the application layer streaming media data block, the TimeStamp is a timestamp, where a Block_SN value and a TimeStamp value are regular, and an initial value of the TimeStamp is a random value, as long as the random value is obtained, the application layer streaming media data block can be processed; the Length is a payload length, and the Payload is payload. For example, for an application layer streaming media data block whose source format is TS stream or TS file, for a first application layer streaming media data block, ST=1, DT=1, Block-SN=1, Timestamp is an initial random value, and Length=1400, which indicates that the Payload contains 1400 TS packets.

It should be noted that, the streaming media server may further send the application layer streaming media data block to the streaming media data encapsulation device by using the defined socket structure type.

It should be further noted that, if the streaming media data encapsulation device does not enable the segmentation and encapsulation function, the streaming media server instructs the streaming media data encapsulation device to enable the segmentation and encapsulation function, so that the streaming media data encapsulation device segments and encapsulates the application layer streaming media data block sent by the streaming media server.

S406: The streaming media data encapsulation device determines a source format and a target format of the application layer streaming media data block.

It should be noted that, a source format and a target format of the application layer streaming media data block may be determined in any one of the following manners:

Manner 1: The application layer streaming media data block carries a source format identifier and a target format identifier, and the streaming media data encapsulation device determines the source format and the target format of the application layer streaming media data block according to the source format identifier and the target format identifier that are carried in the application layer streaming media data block, for example, in the foregoing customized socket structure type, determines the source format and the target format of the application layer streaming media data block by means of an ST identifier and a DT identifier.

Manner 2: The source format and the target format of the application layer streaming media data block are determined according to pre-saved configuration parameters, where the configuration parameters include a source format identifier and a target format identifier of the application layer streaming media data block.

It should be noted that, before obtaining the pre-saved configuration parameters, the streaming media data encapsulation device may pre-receive the configuration parameters sent by the streaming media server, and save the configuration parameters, so that the streaming media data encapsulation device determines the source format and the target format of the application layer streaming media data block according to the pre-saved configuration parameters when receiving the application layer streaming media data block sent by the streaming media server.

It should be noted that, the streaming media server may send the configuration parameters to the streaming media data encapsulation device according to a customized socket (Socket) or a defined socket. The following is used as an example: the source format is TS file or TS stream and the target format is TS/UDP packet, the defined socket may be a socket of a conventional UDP packet type. As an example rather than a limitation, in a specific implementation manner, the configuration parameters may be sent to the streaming media data encapsulation device by using a customized socket option or a defined socket option. For example, an option SO_MEDIA of a SOL_UDP layer or a SOL_SOCKET layer may be defined, the data structure of the configuration parameters and a pointer of the configuration parameters may also be defined at the same time, and the configuration parameters are sent to the streaming media data encapsulation device by using a function setsockopt. In another specific implementation manner, a configuration option is defined for each parameter option that needs to be configured in the configuration parameters, and the configuration parameters are sent to the streaming media data encapsulation device by using the function setsockopt. For example, a source format is defined as TS file or TS stream and a target format is defined as an option SO_MEDIA_TS that enables TS/UDP, where in a specific implementation manner, the value of the option SO_MEDIA_TS is a Boolean type, which may be True or False, where the value True indicates that the source format is a TS format and the target format is TS/UDP. After receiving the application layer streaming media data block in the TS format, the streaming media data encapsulation device segments and encapsulates the application layer streaming media data block in the TS format into a UDP packet in the TS format. A source format configuration option SO_MEDIA_SOURCE may also be defined, and the value of the SO_MEDIA_SOURCE option is an enumeration type, for example, the value of the SO_MEDIA_SOURCE includes SO_MEDIA_SOURCE_TS, SO_MEDIA_SOURCE_H.264, and the like.

It should be noted that, defining the data structure of the configuration parameters specifically refers to defining the data structure of the source format identifier and the data structure of the target format identifier.

S407: The streaming media data encapsulation device determines a size of each data packet according to the source format.

For example, if the source format is TS file or TS stream, the streaming media data encapsulation device determines that the size of each TS packet is 188 bytes.

S408: The streaming media data encapsulation device segments and encapsulates the data packets in the application layer streaming media data block into at least two packets in the target format according to the size of each data packet and the maximum integral number, where each segmented and encapsulated packet in the target format contains the integral number of data packets in the source format.

The data packets in the application layer streaming media data block are segmented and encapsulated into at least two packets in the target format specifically in the following manner:

segmenting the data packets in the application layer streaming media data block into at least two segmentations, where the number of data packets contained in each segment is an integer and not greater than the maximum integral number; and separately encapsulating the at least two segmentations into packets in the target format.

For example, if the source format is TS stream or TS file and the target format is TS/UDP, it indicates that a TS packet in the source format needs to be encapsulated into a UDP packet in the TS format. The size of the TS packet is 188 bytes and an MTU value is 1500 bytes, and therefore a UDP packet can carry a maximum of 7 TS packets, and the application layer streaming media data block may be segmented in a manner where each segment is not greater than 7 TS packets. For example, if the application layer streaming media data block contains 35 TS packets, in a manner where every 5 TS packets are segmented into a segment, the application layer streaming media data block is segmented and encapsulated into 7 UDP packets, where the format of each UDP packet is shown in the following table:

| | | | | | |
|---|---|---|---|---|---|
| UDP head | TS packet | TS packet | TS packet | TS packet | TS packet |

For another example, if the source format is TS stream or TS file and the target format is TS/RTP/UDPTS/RTP/UDP, it indicates that multiple TS packets in the source format need to be first added with an RTP head and encapsulated into packets in an RTP (Real-Time Transport Protocol, Real-Time Transport Protocol) format, and then the packets in the RTP format need to be added with a UDP head and encapsulated into UDP packets. The size of the TS packet is 188 bytes, the UDP head occupies 8 bytes, and the RTP head occupies 12 bytes, and therefore a UDP packet can carry a maximum of 7 TS packets, and the application layer streaming media data block may be segmented in a manner where each segment is not greater than 7 TS packets. For example, in a manner where every 5 TS packets are segmented into a segment, each segmented segment is encapsulated into a UDP packet. The difference of the UDP packet in the RTP format from the UDP packet in the TS format lies in that the UDP packet in the RTP format contains an RTP head, as shown in the following table:

| | | | | | | |
|---|---|---|---|---|---|---|
| UDP | RTP | TS | TS packet | TS packet | TS packet | TS packet |
| head | head | packet | | | | |

It should be noted that, for other target formats, a similar manner may be adopted to expand a corresponding function of the streaming media data encapsulation device. As an example rather than a limitation, if the source format is TS file or TS stream and the target format is TS/TCP, the maximum integral number of TS packets that can be contained in a TCP packet is determined in a similar manner, and the application layer streaming media data block is segmented and encapsulated in a similar manner, which are not repeated again herein.

For other source formats and target formats, for example, if the source format is H.264 and the target format is H.264/RTP/UDP, a similar manner may be adopted to expand corresponding functions of the streaming media data encapsulation device, which is not repeated again herein.

It should be noted that, the data packets in the application layer streaming media data block may be segmented into at least two segments in the following manner:

segmenting the data packets in the application layer streaming media data block into at least two segmentations according to the maximum integral number. For example, when the source format is TS file or TS stream and the target format is TS/RTP/UDP, in a manner where every 7 TS packets are a segment, the application layer streaming media data block is segmented. If the application layer streaming media data block contains 1400 TS packets, the 1400 TS packets are segmented into 200 segments, where each segment contains 7 TS packets, and the 200 segments are separately encapsulated into UDP packets in the RTP format.

S409: The streaming media data encapsulation device sends, to a client, each packet that is in the target format and obtained by using segmentation and encapsulation.

It should be noted that, the streaming media data encapsulation device may send, to a client, each packet that is in the target format and obtained by using segmentation and encapsulation specifically in the following manner:

sending each packet that is in the target format and obtained by using segmentation and encapsulation to the client successively according to pre-saved sending parameters, where the sending parameters include a sending rate and a sending time interval.

It should be noted that, before obtaining the pre-saved sending parameters, the streaming media data encapsulation device may pre-receive the sending parameters sent by the streaming media server, and save the sending parameters.

It should be noted that, while sending the configuration parameters to the streaming media data encapsulation device by using a socket option, the streaming media server may send the sending parameters to the streaming media data encapsulation device. As an example rather than a limitation, if the source format is TS file or TS stream and the target format is TS/UDP, the configuration parameters and the sending parameters may be sent to the streaming media data encapsulation device by using a customized socket option or a defined socket option. For example, an option SO_MEDIA of a SOL_UDP layer or a SOL_SOCKET layer may be defined, the data structure of the configuration parameters and the data structure of the sending parameters may also be defined at the same time, and the configuration parameters and the sending parameters are sent to the streaming media data encapsulation device by using a function setsockopt. In another specific implementation manner, a configuration option is defined for each parameter option that needs to be configured in the configuration parameters and the sending parameters, and the configuration parameters and the sending parameters are sent to the streaming media data encapsulation device by using the function setsockopt. For example, the sending parameters include two parameter options, that is, the sending rate and the sending time interval. For the sending parameters, two configuration options are defined separately for the sending rate and the sending time interval. This is also applicable to the configuration parameters is similar, which is not repeated again herein.

Optionally, the sending parameters may further include the size of a buffer, and the streaming media data encapsulation device sets a cache according to the size of the buffer.

In the method embodiment provided by the embodiment of the present invention, the number of data packets in an application layer streaming media data block is greater than the maximum integral number of data packets that are in a source format and can be contained in one packet in a target format, thereby decreasing the number of times of communication between a streaming media server and a streaming media data encapsulation device, and reducing the processing load of the streaming media server; in addition, the streaming media server sends the application layer streaming media data block to the streaming media data encapsulation device, and the streaming media data encapsulation device encapsulates the application layer streaming media data block, thereby further reducing the processing load of the streaming media server; in addition, the streaming media data encapsulation device segments and encapsulates the application layer streaming media data block according to a source format and a target format of the application layer streaming media data block, so that the streaming media data encapsulation device can adaptively encapsulate various types of application layer streaming media data blocks; in addition, the application layer streaming media data block carries a source format identifier and a target format identifier, so that the streaming media data encapsulation device can simultaneously process various types of application layer streaming media data blocks; in addition, the source format and the target format of the application layer streaming media data block can be learned by using pre-saved configuration parameters, thereby further reducing overheads of communication between the streaming media server and the streaming media data encapsulation device, and saving network bandwidth; further, the packet in the target format that is encapsulated by the streaming media data encapsulation device contains the integral number of data packets in the source format, thereby simplifying the complexity of the encapsulation processing; and furthermore, the streaming media data encapsulation device segments the data packets in the application layer streaming media data block according to the maximum integral number of data packets in the source format that can be contained in the packet in the target format, so that each encapsulated packet in the target format contains the maximum number of data packets, thereby decreasing the number of times of communication between the streaming media data encapsulation device and a client, and reducing the processing load of the streaming media data encapsulation device. In addition, the streaming media server determines the number of data packets in the application layer streaming media data block according to real time of a streaming media service, thereby ensuring playing continuity of streaming media data, and improving user experience; moreover, the number of data packets in the application layer streaming media data block is an integral multiple of the maximum integral number, thereby helping the streaming media data encapsulation device segment and encapsulate the application layer streaming media data block, and simplifying the complexity of the encapsulation processing; and finally, the streaming media data encapsulation device sends the packet in the target format to the client according to pre-saved sending parameters, so that the streaming media data encapsulation device can adaptively send the packet in the target format to the client, thereby ensuring that the demand of services can be satisfied.

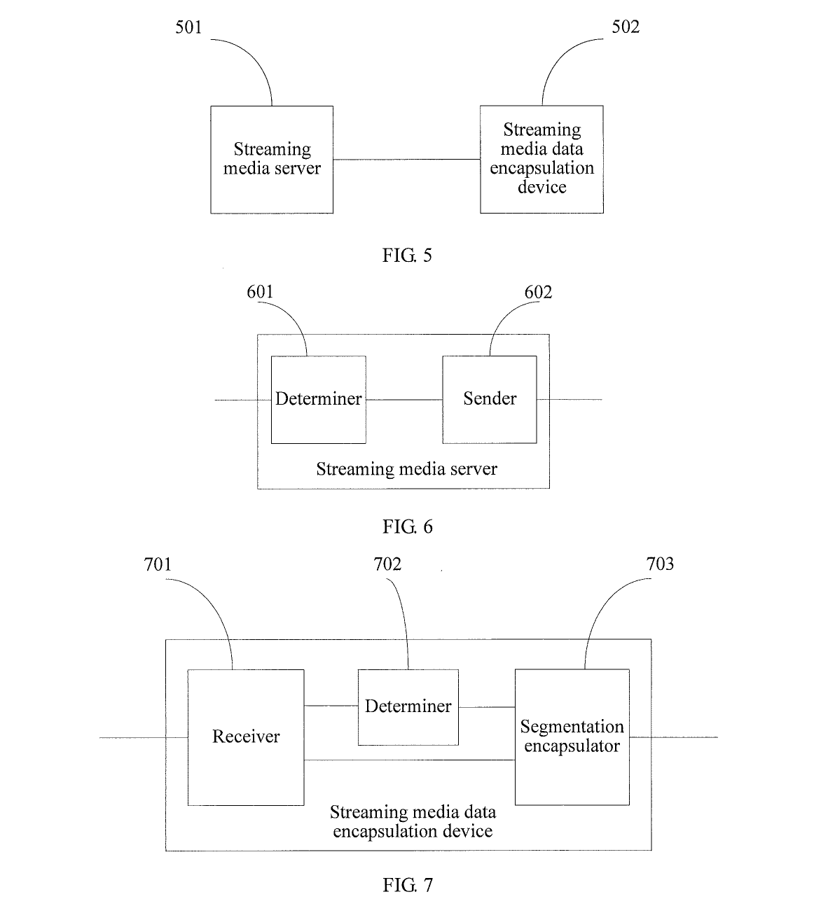

As shown in FIG. 5, FIG. 5 is a system for processing streaming media data according to an embodiment of the present invention, which includes a streaming media server 501 and a streaming media data encapsulation device 502, where,

the streaming media server 501 is configured to determine a source format and a target format of application layer streaming media data, and send an application layer streaming media data block to the streaming media data encapsulation device 502 after determining, according to the source format and the target format, the maximum integral number of data packets that are in the source format and can be contained in one packet in the target format, where the number of data packets in the application layer streaming media data block is greater than the maximum integral number; and

the streaming media data encapsulation device 502 is configured to receive the application layer streaming media data block sent by the streaming media server 501, determine a source format and a target format of the application layer streaming media data block, determine a size of each data packet in the application layer streaming media data block according to the source format, and segment and encapsulate the data packets in the application layer streaming media data block into at least two packets in the target format according to the size of each data packet and the maximum integral number, where each segmented and encapsulated packet in the target format contains the integral number of data packets in the source format.

In the system for processing streaming media data that is provided by the embodiment of the present invention, the number of data packets in an application layer streaming media data block is greater than the maximum integral number of data packets that are in a source format and can be contained in one packet in a target format, thereby decreasing the number of times of communication between a streaming media server and a streaming media data encapsulation device, and reducing the processing load of the streaming media server; in addition, the streaming media server sends the application layer streaming media data block to the streaming media data encapsulation device, and the streaming media data encapsulation device segments and encapsulates the application layer streaming media data block, thereby further reducing the processing load of the streaming media server.

As shown in FIG. 6, FIG. 6 is a streaming media server according to an embodiment of the present invention, where the streaming media server may be applied to the system for processing streaming media data, and the streaming media server includes:

a determiner 601, configured to determine a source format and a target format of application layer streaming media data, where

the determiner 601 is further configured to determine, according to the source format and the target format, the maximum integral number of data packets that are in the source format and can be contained in one packet in the target format; and

a sender 602, configured to send an application layer streaming media data block to a streaming media data encapsulation device, where the number of data packets in the application layer streaming media data block is greater than the maximum integral number determined by the determiner 601.

It should be noted that, the determiner 601 is further configured to determine the number of data packets in the application layer streaming media data block according to real time of a streaming media service.

It should be further noted that, the determiner 601 is specifically configured to determine the number of data packets in the application layer streaming media data block according to an average play speed of streaming media data and a sending time interval of sending the application layer streaming media data block.

It should be noted that, the sender 602 is further configured to send configuration parameters to the streaming media data encapsulation device, where the configuration parameters include a source format identifier and a target format identifier, so that the streaming media data encapsulation device segments and encapsulates the application layer streaming media data block into at least two packets in the target format according to the configuration parameters.

It should be noted that, the sender 602 is further configured to send sending parameters to the streaming media data encapsulation device, where the sending parameters include a sending rate and a sending time interval, so that the streaming media data encapsulation device successively sends, to a client, each packet that is in the target format and obtained by using segmentation and encapsulation according to the sending parameters.

It should be noted that, the determiner 601 is further configured to determine, according to the maximum integral number, the number of read data packets for reading the application layer streaming media data each time; and

the server further includes:

a data reader, configured to read the application layer streaming media data according to the number of read data packets that is determined by the determiner 602.

It should be noted that, the number of read data packets that is determined by the determiner 601 may be greater than the maximum integral number.

In the streaming media server provided by the embodiment of the present invention, the number of data packets in an application layer streaming media data block sent by a sender to a streaming media data encapsulation device is greater than the maximum integral number of data packets that are in a source format and can be contained in one packet in a target format, thereby decreasing the number of times of communication between the streaming media server and the streaming media data encapsulation device, and reducing the processing load of the streaming media server; in addition, the sender sends the application layer streaming media data block to the streaming media data encapsulation device, and the streaming media data encapsulation device segments and encapsulates the application layer streaming media data block, thereby further reducing the processing load of the streaming media server; in addition, a determiner determines the number of data packets in the application layer streaming media data block according to real time of a streaming media service, thereby ensuring playing continuity of streaming media data, and improving user experience.

As shown in FIG. 7, FIG. 7 is a streaming media data encapsulation device according to an embodiment of the present invention, where the streaming media data encapsulation device may be applied to the system for processing streaming media data, and the streaming media data encapsulation device includes:

a receiver 701, configured to receive an application layer streaming media data block sent by a streaming media server;

a determiner 702, configured to determine a source format and a target format of the application layer streaming media data block received by the receiver 701, where the number of data packets in the application layer streaming media data block received by the receiver is greater than the maximum integral number of data packets that are in the source format and can be contained in one packet in the target format, where,

the determiner 702 is further configured to determine a size of each data packet according to the source format; and

a segmentation encapsulator 703, configured to segment and encapsulate the data packets in the application layer streaming media data block received by the receiver 701 into at least two packets in the target format according to the size of each data packet that is determined by the determiner 702 and the maximum integral number, where each segmented and encapsulated packet in the target format contains the integral number of data packets in the source format.

It should be noted that, the segmentation encapsulator 703 includes:

a segmenter, configured to segment the data packets in the application layer streaming media data block into at least two segments according to the size of each data packet that is determined by the determiner 702 and the maximum integral number, where the number of data packets contained in each segmentation is an integer and not greater than the maximum integral number; and

an encapsulator, configured to separately encapsulate the at least two segments obtained by using segmentation of the segmenter into packets in the target format.

It should be noted that, the segmenter is specifically configured to segment the data packets in the application layer streaming media data block into at least two segments according to the maximum integral number.

It should be noted that, the receiver 701 is specifically configured to receive the application layer streaming media data block sent by the streaming media server, where the number of data packets in the application layer streaming media data block is an integral multiple of the maximum integral number.

It should be further noted that, the receiver 701 is specifically configured to receive the application layer streaming media data block sent by the streaming media server, where the streaming media server determines the number of data packets in the application layer streaming media data block according to real time of a service, where in a specific implementation manner, the streaming media server determines the number of data packets in the application layer streaming media data block according to an average play speed of streaming media data and a sending time interval of sending the application layer streaming media data block.

It should be noted that, the determiner 702 is specifically configured to determine the source format and the target format of the application layer streaming media data block according to a source format identifier and a target format identifier that are carried in the application layer streaming media data block received by the receiver 701.

It should be noted that, the determiner 702 may be further specifically configured to determine, according to pre-saved configuration parameters, the source format and the target format of the application layer streaming media data block received by the receiver 701, where the configuration parameters include a source format identifier and a target format identifier of the application layer streaming media data block.

It should be further noted that, the receiver 701 is further configured to pre-receive the configuration parameters sent by the streaming media server; and

the device further includes:

a first memory, configured to save the configuration parameters received by the receiver 701.

It should be noted that, the device further includes:

a sender, configured to send, to a client, each packet that is in the target format and obtained by using encapsulation of the segmentation encapsulator 703.

It should be noted that, the sender is specifically configured to successively send, to the client, each packet that is in the target format and obtained by using encapsulation of the segmentation encapsulator 703 according to pre-saved sending parameters, where the sending parameters include a sending rate and a sending time interval.

It should be further noted that, the receiver 701 is further configured to pre-receive the sending parameters sent by the streaming media server; and

the device further includes:

a second memory, configured to save the sending parameters received by the receiver 701.

In the method, the apparatus, and the system for processing streaming media data that are provided by the embodiments of the present invention, the number of data packets in an application layer streaming media data block is greater than the maximum integral number of data packets that are in a source format and can be contained in one packet in a target format, thereby decreasing the number of times of communication between a streaming media server and a streaming media data encapsulation device, and reducing the processing load of the streaming media server; in addition, the streaming media server sends the application layer streaming media data block to the streaming media data encapsulation device, and the streaming media data encapsulation device encapsulates the application layer streaming media data block, thereby further reducing the processing load of the streaming media server; in addition, the streaming media data encapsulation device segments and encapsulates the application layer streaming media data block according to a source format and a target format of the application layer streaming media data block, so that the streaming media data encapsulation device can adaptively encapsulate various types of application layer streaming media data blocks; in addition, the application layer streaming media data block carries a source format identifier and a target format identifier, so that the streaming media data encapsulation device can simultaneously process various types of application layer streaming media data blocks; in addition, the source format and the target format of the application layer streaming media data block can be learned by using pre-saved configuration parameters, thereby further reducing overheads of communication between the streaming media server and the streaming media data encapsulation device, and saving network bandwidth; further, the packet in the target format that is encapsulated by the streaming media data encapsulation device contains the integral number of data packets in the source format, thereby simplifying the complexity of the encapsulation processing; furthermore, the streaming media data encapsulation device segments the data packets in the application layer streaming media data block according to the maximum integral number of data packets that are in the source format and can be contained in the packet in the target format, so that each encapsulated packet in the target format contains the maximum number of data packets, thereby decreasing the number of times of communication between the streaming media data encapsulation device and a client, and reducing the processing load of the streaming media data encapsulation device; in addition, the number of data packets in the application layer streaming media data block is an integral multiple of the maximum integral number, thereby helping the streaming media data encapsulation device segment and encapsulate the application layer streaming media data block, and simplifying the complexity of the encapsulation processing; and the streaming media server determines the number of data packets in the application layer streaming media data block according to real time of a streaming media service, thereby ensuring playing continuity of streaming media data, and improving user experience; furthermore, the streaming media server sends the application layer streaming media data block to the streaming media data encapsulation device according to an average play speed of the streaming media data and a sending time interval of sending the application layer streaming media data block, so as to satisfy the demand of real-time services; and finally, the streaming media data encapsulation device sends the packet in the target format to the client according to pre-saved sending parameters, so that the streaming media data encapsulation device can adaptively send the packet in the target format to the client, thereby ensuring that the demand of services can be satisfied.

Through the description of the implementation manners, a person of ordinary skill in the art may clearly understand that, each implementation manner may be implemented by means of software plus a necessary general hardware platform, or may be implemented by using dedicated hardware. Based on such understanding, the foregoing technical solutions essentially or the part contributing to the prior art may be reflected in a form of a software product, and the computer software product may be stored in a computer readable storage medium, such as a ROM/RAM, a magnetic disk, or an optical disc, and include a plurality of instructions for enabling a computer device (which may be a personal computer, a server, a network device, or various handheld terminals) to execute each embodiment or the method of some parts of the embodiments.

In conclusion, the foregoing descriptions are merely exemplary embodiments of the present invention, but are not intended to limit the scope of the present invention. Any modifications, equivalent replacements, or improvements made within the spirit and principle of the present invention shall fall within the protection scope of the present invention.

What is claimed is:

1. A method for processing streaming media data, comprising:
determining, by a streaming media server, a source format and a target format of application layer streaming media data;
determining, by the streaming media server, according to the source format and the target format, the maximum integral number of data packets that are in the source format and can be contained in one packet in the target format; and
sending, by the streaming media server, an application layer streaming media data block to a streaming media data encapsulation device, wherein the number of data packets in the application layer streaming media data block is greater than the maximum integral number.

2. The method according to claim 1, further comprising:
determining, by the streaming media server, the number of data packets in the application layer streaming media data block according to real time of a streaming media service.

3. The method according to claim 2, wherein the determining, by the streaming media server, the number of data packets in the application layer streaming media data block according to real time of a streaming media service comprises:
determining, by the streaming media server, the number of data packets in the application layer streaming media data block according to an average play speed of streaming media data and a sending time interval of sending the application layer streaming media data block.

4. The method according to claim 1, wherein the number of data packets in the application layer streaming media data block is an integral multiple of the maximum integral number.

5. The method according to claim 1, further comprising:
sending, by the streaming media server, configuration parameters to the streaming media data encapsulation device, wherein the configuration parameters comprise a source format identifier and a target format identifier, so that the streaming media data encapsulation device segments and encapsulates the application layer streaming media data block into at least two packets in the target format according to the configuration parameters.

6. The method according to claim 5, further comprising:
sending, by the streaming media server, sending parameters to the streaming media data encapsulation device, wherein the sending parameters comprise a sending rate and a sending time interval, so that the streaming media data encapsulation device successively sends, to a client, each packet that is in the target format and obtained by using segmentation and encapsulation according to the sending parameters.

7. A method for processing streaming media data, comprising:
receiving an application layer streaming media data block sent by a streaming media server;
determining a source format and a target format of the application layer streaming media data block, wherein the number of data packets in the application layer streaming media data block is greater than the maximum integral number of data packets that are in the source format and can be contained in one packet in the target format; and
determining a size of each data packet in the application layer streaming media data block according to the source format, and segmenting and encapsulating the data packets in the application layer streaming media data block into at least two packets in the target format according to the size of each data packet and the maximum integral number, wherein each segmented and encapsulated packet in the target format contains the integral number of data packets in the source format.

8. The method according to claim 7, wherein the segmenting and encapsulating the data packets in the application layer streaming media data block into at least two packets in the target format comprises:
segmenting the data packets in the application layer streaming media data block into at least two segments, wherein the number of data packets contained in each segment is an integer and not greater than the maximum integral number; and
separately encapsulating the at least two segments into packets in the target format.

9. The method according to claim 8, wherein the segmenting the data packets in the application layer streaming media data block into at least two segments comprises:
segmenting the data packets in the application layer streaming media data block into at least two segments according to the maximum integral number.

10. The method according to claim 7, wherein the application layer streaming media data block carries a source format identifier and a target format identifier; and
the determining a source format and a target format of the application layer streaming media data block comprises:
determining the source format and the target format of the application layer streaming media data block according to the source format identifier and the target format identifier that are carried in the application layer streaming media data block.

11. The method according to claim 7, wherein the determining a source format and a target format of the application layer streaming media data block comprises:
determining the source format and the target format of the application layer streaming media data block according to pre-saved configuration parameters, wherein the configuration parameters comprise a source format identifier and a target format identifier of the application layer streaming media data block.

12. The method according to claim 7, after the segmenting and encapsulating the data packets in the application layer streaming media data block into at least two packets in the target format, further comprising:
sending, to a client, each packet that is in the target format and obtained by using segmentation and encapsulation.

13. The method according to claim 12, wherein the sending, to a client, each packet that is in the target format and obtained by using segmentation and encapsulation comprises:
successively sending, to the client, each packet that is in the target format and obtained by using segmentation and encapsulation according to pre-saved sending parameters, wherein the sending parameters comprise a sending rate and a sending time interval.

14. A streaming media server, comprising:
a determiner, configured to determine a source format and a target format of application layer streaming media data, wherein,
the determiner is further configured to determine, according to the source format and the target format, the maximum integral number of data packets that are in the source format and can be contained in one packet in the target format; and
a sender, configured to send an application layer streaming media data block to a streaming media data encapsulation device, wherein the number of data packets in the application layer streaming media data block is greater than the maximum integral number determined by the determiner.

15. The server according to claim 14, wherein the determiner is further configured to determine the number of data packets in the application layer streaming media data block according to real time of a streaming media service.

16. The server according to claim 15, wherein the determiner is specifically configured to determine the number of data packets in the application layer streaming media data block according to an average play speed of streaming media data and a sending time interval of sending the application layer streaming media data block.

17. The server according to claim 14, wherein the sender is further configured to send configuration parameters to the streaming media data encapsulation device, wherein the configuration parameters comprise a source format identifier and a target format identifier, so that the streaming media data encapsulation device segments and encapsulates the application layer streaming media data block into at least two packets in the target format according to the configuration parameters.

18. The server according to claim 14, wherein the sender is further configured to send sending parameters to the streaming media data encapsulation device, wherein the sending parameters comprise a sending rate and a sending time interval, so that the streaming media data encapsulation device successively sends, to a client, each packet that is in the target format and obtained by using segmentation and encapsulation according to the sending parameters.

19. A streaming media data encapsulation device, comprising:
a receiver, configured to receive an application layer streaming media data block sent by a streaming media server;
a determiner, configured to determine a source format and a target format of the application layer streaming media data block received by the receiver, wherein the number of data packets in the application layer streaming media data block received by the receiver is greater than the maximum integral number of data packets that are in the source format and can be contained in one packet in the target format, wherein,
the determiner is further configured to determine a size of each data packet according to the source format; and
a segmentation encapsulator, configured to segment and encapsulate the data packets in the application layer streaming media data block received by the receiver into at least two packets in the target format according to the size of each data packet that is determined by the determiner and the maximum integral number, wherein each segmented and encapsulated packet in the target format contains the integral number of data packets in the source format.

20. The device according to claim 19, wherein the segmentation encapsulator comprises:
a segmenter, configured to segment the data packets in the application layer streaming media data block into at least two segments according to the size of each data packet that is determined by the determiner and the maximum integral number, wherein the number of data packets contained in each segmentation is an integer and not greater than the maximum integral number; and
an encapsulator, configured to separately encapsulate the at least two segments obtained by using segmentation of the segmenter into packets in the target format.

21. The device according to claim 20, wherein the segmenter is specifically configured to segment the data packets in the application layer streaming media data block into at least two segments according to the maximum integral number.

22. The device according to claim 19, wherein the determiner is specifically configured to determine the source format and the target format of the application layer streaming media data block according to a source format identifier and a target format identifier that are carried in the application layer streaming media data block received by the receiver.

23. The device according to claim 19, wherein the determiner is specifically configured to determine, according to pre-saved configuration parameters, the source format and the target format of the application layer streaming media data block received by the receiver, wherein the configuration parameters comprise a source format identifier and a target format identifier of the application layer streaming media data block.

24. The device according to claim 19, further comprising:
a sender, configured to send, to a client, each packet that is in the target format and obtained by using encapsulation of the segmentation encapsulator.

25. The device according to claim 24, wherein the sender is specifically configured to successively send, to the client, each packet that is in the target format and obtained by using encapsulation of the segmentation encapsulator according to pre-saved sending parameters, wherein the sending parameters comprise a sending rate and a sending time interval.
